(19) United States
(12) Patent Application Publication
(10) Pub. No.: US 2023/0216228 A1
(43) Pub. Date: Jul. 6, 2023

(54) CONTACT MEMBER AND ELECTRICAL TERMINAL FOR ELECTRICALLY CONDUCTIVE STRUCTURES

(71) Applicant: Lear Corporation, Southfield, MI (US)

(72) Inventors: Chao Fang, Shanghai (CN); Jiayun Chen, Shanghai (CN)

(73) Assignee: Lear Corporation, Southfield, MI (US)

(21) Appl. No.: 18/091,661

(22) Filed: Dec. 30, 2022

(30) Foreign Application Priority Data
Dec. 31, 2021 (CN) 202111670153.3

(51) Int. Cl. H01R 13/11

(52) U.S. Cl. CPC H01R 13/113

(57) ABSTRACT

Contact members and electrical terminals are described. An example contact member has a first panel, a second panel, and an interspace defined between the first panel and the second panel. Each of the first and second panels has a plurality of posts. Each post of the plurality of posts has a plurality of slots and a contact point. Each slot of the plurality of slots is disposed adjacent to the contact point. Each post of the plurality of posts extends into the interspace such that the contact point is disposed within the interspace. Each post of the plurality of posts is moveable between a first position and a second position to accommodate retention of an electrically conductive structure and an electrical connection between the electrically conductive structure and the contact member.

### FIELD

The disclosure relates generally to the field of contact members and electrical terminals that facilitate electrical connections between two electrically conductive structures. More particularly, the disclosure relates to a contact member and an electrical terminal for electrically conductive structures.

### BACKGROUND

Electrical terminals are generally provided on a terminal end of an electrical conductor in an electrical system to complete a connection between one or more electrically operated devices and a source of electrical energy and/or other components of the electrical system. The electrical terminals facilitate the installation, service, and removal of these electrically operated devices to and from the electrical system.

Electrical terminals generally include a contact member that electrically connects a first electrically conductive structure and a second electrically conductive structure. For example, engagement of the first electrically conductive structure, such as an electrical blade, with the electrical terminal can be accomplished by inserting a portion of the first electrically conductive structure into an interspace defined by the contact member of the electrical terminal. Engagement with the second electrically conductive structure with the electrical terminal can be accomplished by crimping an end of the electrical terminal onto a portion of the second electrically conductive structure (e.g., an electrically conductive material). Such crimping is accomplished using of a variety of specialized tools and/or specialized methods. Contact members currently included in electrical terminals have various structural arrangements, resulting in a variety of current and retention performances. It is desirable to provide an improved structure for a contact member and an electrical terminal that includes a contact member such that a quick, easy, effective, and secure connection between two electrically conductive structures can be accomplished.

A need exists, therefore, for new and useful contact members and electrical terminals for electrically conductive structures.

### SUMMARY

Various example contact members and electrical terminals are described.

An example contact member has a first panel, a second panel, and an interspace defined between the first panel and the second panel. Each of the first and second panels has a plurality of posts. Each post of the plurality of posts has a plurality of slots and a contact point. Each slot of the plurality of slots is disposed adjacent to the contact point. Each post of the plurality of posts extends into the interspace such that the contact point is disposed within the interspace. Each post of the plurality of posts is moveable between a first position and a second position. In the first position, the contact point of each post of the plurality of posts of the first panel is disposed a first distance from the second panel. In the second position, the contact point of each post of the plurality of posts of the first panel is disposed a second distance from the second panel that is greater than the first distance.

An example electrical terminal has a terminal body portion, a housing, and a contact member. The housing extends from the terminal body portion and defines a hollow socket. The contact member is retained within the hollow socket. The contact member includes a first panel, a second panel, and defines an interspace between the first panel and the second panel. Each of the first and second panels has a plurality of posts. Each post of the plurality of posts has a plurality of slots and a contact point. Each slot of the plurality of slots is disposed adjacent to the contact point. Each post of the plurality of posts extends into the interspace such that the contact point is disposed within the interspace. Each post of the plurality of posts is moveable between a first position and a second position. In the first position, the contact point of each post of the plurality of posts of the first panel is disposed a first distance from the second panel. In the second position, the contact point of each post of the plurality of posts of the first panel is disposed a second distance from the second panel that is greater than the first distance.

Another example electrical terminal has a terminal body portion, a housing, and a contact member. The housing extends from the terminal body portion and defines a first opening, a second opening, and a hollow socket. Each of the first and second openings provides access to the hollow socket. The contact member is retained within the hollow socket. The contact member includes a first panel, a second panel, and defines an interspace between the first panel and the second panel. Each of the first and second panels has a plurality of posts. Each post of the plurality of posts has a plurality of slots, a contact point, a recess entirely surrounding the contact point, a projection, and a contact point recess. Each slot of the plurality of slots is disposed adjacent to the contact point and extends radially outward from the contact point. Each post of the plurality of posts extends into the interspace such that the contact point is disposed within the interspace. The projection entirely surrounds the contact point recess. Each post of the plurality of posts is moveable between a first position and a second position. In the first position, the contact point of each post of the plurality of posts of the first panel is disposed a first distance from the second panel. In the second position, the contact point of each post of the plurality of posts of the first panel is disposed a second distance from the second panel that is greater than the first distance.

Additional understanding of these examples can be obtained by review of the detailed description, below, and the appended drawings.

### BRIEF DESCRIPTION OF THE DRAWINGS

FIG. 1 is a partial perspective view of a first embodiment of an electrical terminal. First, second, and third electrically conductive structures are positioned adjacent to the electrical terminal.

FIG. 2 is a perspective sectional view of the electrical terminal illustrated in FIG. 1 taken along the lengthwise axis of the electrical terminal. The electrically conductive structures have been omitted for clarity.

FIG. 3 is a perspective view of the contact member of the electrical terminal illustrated in FIG. 1.

FIG. 3A is a magnified view of area A-A in FIG. 3.

FIG. 4 is a perspective sectional view of the contact member illustrated in FIG. 3 taken along the lengthwise axis of the contact member.

FIG. 4A is a magnified view of area B-B in FIG. 4.

FIG. 5 is a perspective view of the electrical terminal illustrated in FIG. 1. The second electrically conductive structure is positioned adjacent to the first opening defined by the housing of the electrical terminal.

FIG. 6 is a sectional view of the electrical terminal and second electrically conductive structure illustrated in FIG. 5 taken along line 6-6.

FIG. 7 is another perspective view of the electrical terminal illustrated in FIG. 1. The second electrically conductive structure is disposed within the first opening defined by the housing of the electrical terminal and within the interspace defined by the contact member.

FIG. 8 is a sectional view of the electrical terminal and second electrically conductive structure illustrated in FIG. 7 taken along line 8-8.

FIG. 9 is another perspective view of the electrical terminal illustrated in FIG. 1. The third electrically conductive structure is disposed within the second opening defined by the housing of the electrical terminal and within the interspace defined by the contact member.

FIG. 10 is a perspective view of an alternative contact member for use with an electrical terminal.

FIG. 11 is a perspective sectional view of an alternative terminal body portion and housing for use with an electrical terminal taken along the lengthwise axis of the terminal body portion and housing.

FIG. 12 is a perspective view of a contact member for use with the terminal body portion and housing illustrated in FIG. 11.

FIG. 13 is perspective sectional view of the contact member illustrated in FIG. 12 taken along the lengthwise axis of the contact member.

FIG. 14 is a perspective sectional view of an alternative electrical terminal.

FIG. 15 is another perspective sectional view of the electrical terminal illustrated in FIG. 14.

FIG. 16 is a perspective view of the second contact member of the electrical terminal illustrated in FIG. 14.

FIG. 17 is an elevation view of a panel of an alternative contact member for use with the terminal body portion and housing illustrated in FIGS. 14 and 15.

### DETAILED DESCRIPTION

The following detailed description and the appended drawings describe and illustrate various example embodiments of a contact member and an electrical terminal. The description and illustration of these examples are provided to enable one skilled in the art to make and use a contact member and an electrical terminal according to this invention. They are not intended to limit the scope of the claims in any manner.

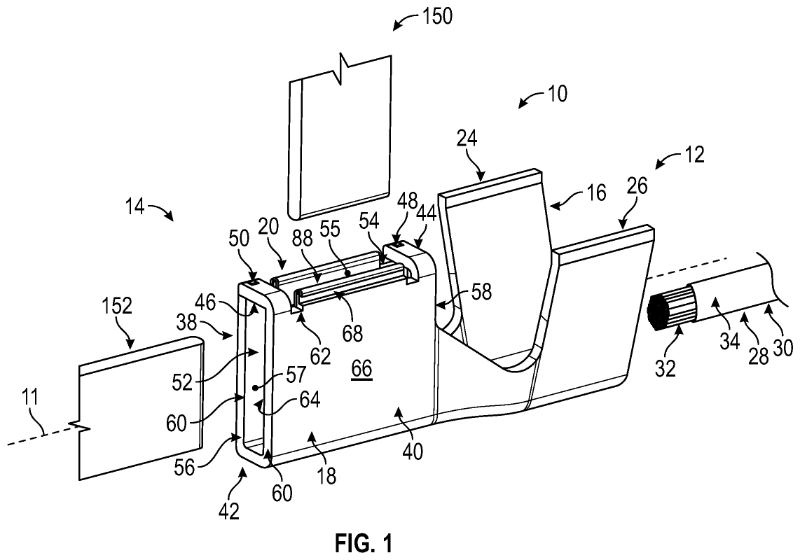

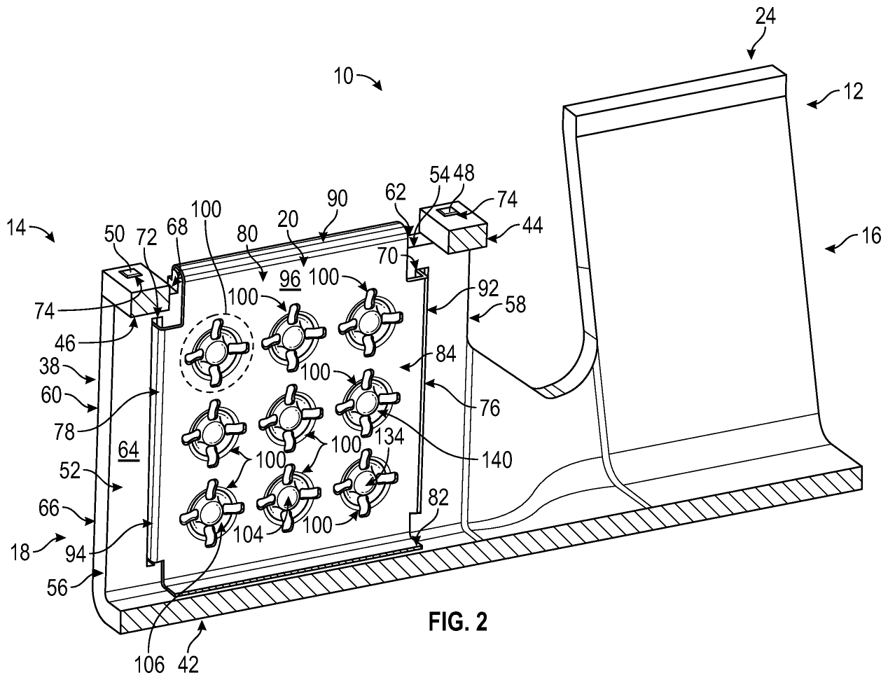

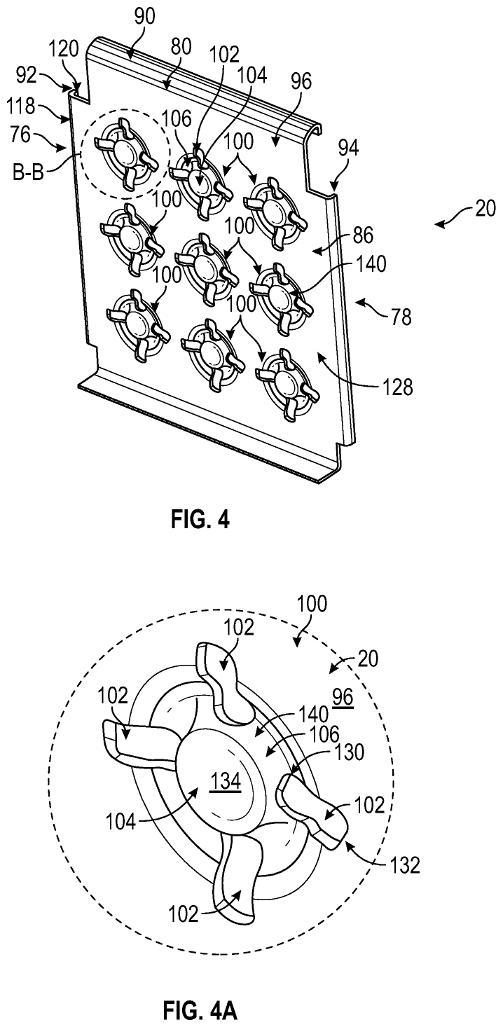

FIGS. 1 through 9 illustrate a first embodiment of an electrical terminal 10 that has a lengthwise axis 11, a first end 12, a second end 14, a terminal body portion 16, a housing 18, and a contact member 20. In the illustrated embodiment, the electrical terminal 10 is a female electrical terminal.

In the illustrated embodiment, the terminal body portion 16 extends from the first end 12 of the electrical terminal 10 towards the second end 14 and comprises first and second wings 24, 26 that are adapted to be crimped onto a first electrically conductive structure 28. As shown in FIG. 1, the first electrically conductive structure 28 is a wire member 30 that includes an electrically conductive material 32 surrounded by an outer electrically non-conductive insulator 34. When assembled, the electrically conductive material 32 contacts the terminal body 16 and/or the housing 18 and the first and second wings 24, 26 are crimped onto the electrically conductive material 32 to accomplish an electrically conductive connection between the electrical terminal 10 and the first electrically conductive structure 28. While a particular structural arrangement has been shown for the terminal body portion 16, a terminal body portion can have any suitable structural arrangement capable of accomplishing an electrically conductive connection between an electrical terminal and an electrically conductive structure.

The housing 18 extends from the second end 14 of the electrical terminal 10 towards the first end 12 to the terminal body portion 16. The housing 18 includes a first plate 38, a second plate 40, a base plate 42, a first connecting arm 44, a second connecting arm 46, a first projection 48, a second projection 50, and defines a hollow socket 52, a first opening 54, and a second opening 56. As shown in FIG. 6, the first plate 38 is disposed a distance 39 from the second plate 40. Each of the first and second plates 38, 40 has a first end 58, a second end 60, a top 62, an inner surface 64, and outer surface 66, and defines a projection 68, a first recess 70, and a second recess 72. The first plate 38 extends from the base plate 42 to the top 62 of the first plate 38. The second plate 40 extends from the base plate 42 to the top 62 of the second plate 40.

Each of the first and second projections 48, 50 is disposed on the first plate 38. Each of the first and second connecting arms 44, 46 defines a passageway 74 and extends from the top 62 of the second plate 40 toward the first plate 38 such that the first projection 48 is disposed within the passageway 74 defined by the first connecting arm 44 and the second projection 50 is disposed within the passageway 74 defined by the second connecting arm 46. While connecting arms 44, 46 and projections 48, 50 have been illustrated as connecting the first and second plates 38, 40, any suitable structure can be used to attach a first plate to a second plate. Alternatively, connecting arms can be omitted from a housing.

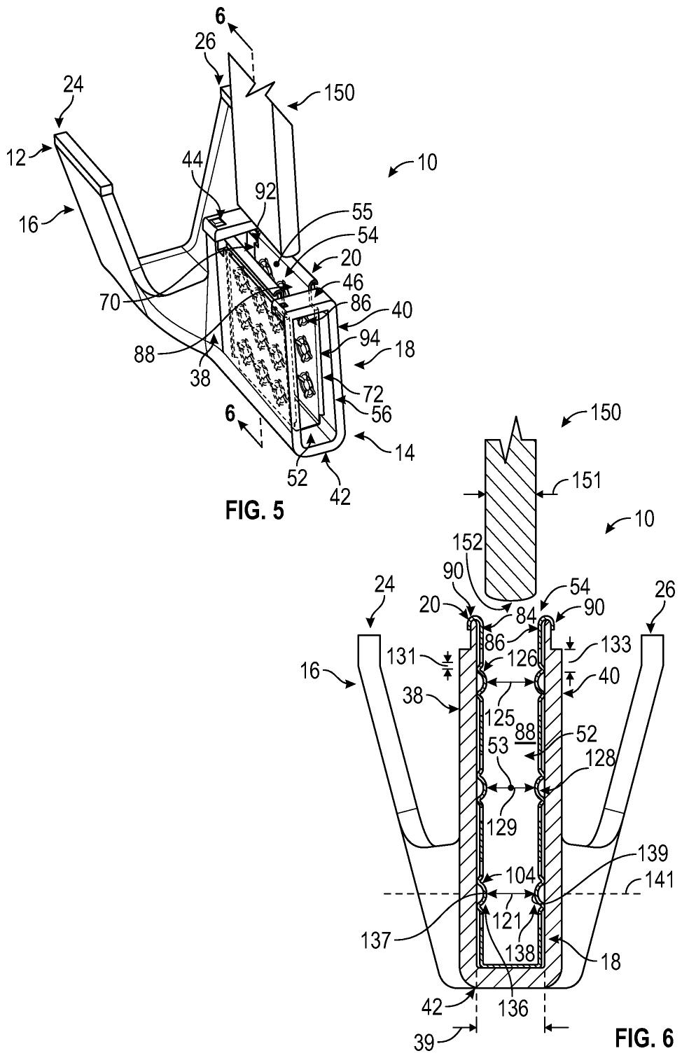

The hollow socket 52 is defined between the first plate 38 and the second plate 40 and has a hollow socket center 53, as shown in FIG. 6. Each of the first and second openings 54, 56 provides access to the hollow socket 52. The first opening 54 is defined between the top 62 of the first plate 38 and the top 62 of the second plate 40, between the first end 12 and the second end 14 of the electrical terminal 10, and has a second opening center 55, as shown in FIGS. 1 and 5. The second opening 56 is defined on the second end 14 of the electrical terminal 10 and has a second opening center 57, as shown in FIG. 1. The first opening center 55 is offset from the second opening center 57 by about 90 degrees relative to the hollow socket center 53. However, alternative embodiments can include opening centers that are offset by any suitable angle, such as angles greater than 45 degrees.

The projection 68 defined by each of the first and second plates 38, 40 extends from the top 62, away from the bottom plate 42, and is sized to be received by a recess 116 defined by a top retaining arm 90 of the contact member 20, as described in more detail herein. Each of the first and second recesses 70, 72 defined by each of the first and second plates 38, 40 is elongated and extends from the inner surface 64 toward the outer surface 66. The first recess 70 is sized to receive a first side retaining arm 92 of the contact member 20 and the second recess 72 is sized to receive a second side retaining arm 94 defined by the contact member 20, as described in more detail herein. In the illustrated embodiment, the first and second recesses 70, 72 are disposed parallel to one another. However, in alternative embodiments, a recess can have any suitable structural arrangement and be disposed at any suitable angle relative to another recess.

While the terminal body portion 16 and the housing 18 have been illustrated as having a particular structural arrangement, a terminal body portion and a housing can have any suitable structural arrangement and be formed of any suitable material. Selection of a suitable structural arrangement can be based on various considerations, including the intended use of the electrical terminal of which the terminal body portion and the housing are a component. For example, while the terminal body portion has been illustrated as including first and second wings such that a crimped connection can be accomplished between the terminal body portion and an electrically conductive structure, alternative embodiments can utilize any suitable structure (e.g., electrical connectors) on a terminal body portion to accomplish attachment to an electrically conductive structure. Examples of materials considered suitable to form a terminal body portion and/or a housing include electrically conductive materials.

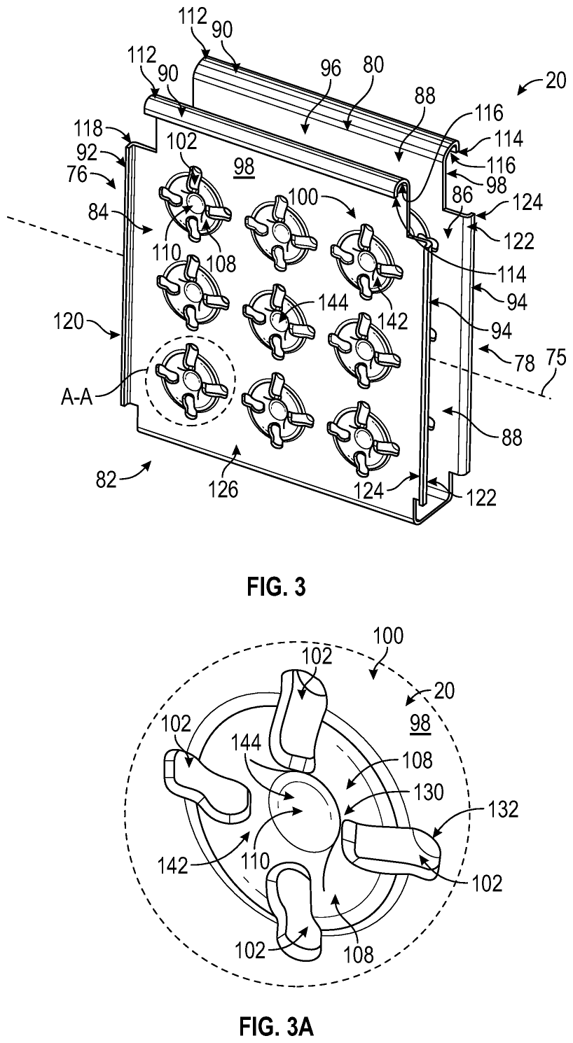

The contact member 20 is retained within the hollow socket 52 defined by the housing 18. As shown in FIG. 3, the contact member 20 has a lengthwise axis 75, a first end 76, a second end 78, a top 80, a bottom 82, a first panel 84, a second panel 86, and defines an interspace 88 between the first and second panels 84, 86. Each of the first and second panels 84, 86 has a top retaining arm 90, a first side retaining arm 92, a second side retaining arm 94, an inner surface 96, and outer surface 98, and a plurality of posts 100. Each post of the plurality of posts 100 has a plurality of slots 102, a contact point 104, a recess 106, a projection 108, and a contact point recess 110. In the illustrated embodiment, the contact member 20 is generally U-shaped.

The top retaining arm 90 extends from the top 80 and defines a curve 112, a top retaining arm end 114, and a recess 116. The curve 112 extends from the top 80 about 180 degrees to the top retaining arm end 114. When assembled, the projection 68 of the first plate 38 is disposed within the recess 116 defined by the top retaining arm 90 of the first panel 84 and the projection 68 of the second plate 40 is disposed within the recess 116 defined by the top retaining arm 90 of the second panel 86. The first side retaining arm 92 extends from the first end 76 and defines a curve 118 and a first retaining arm end 120. The curve 118 extends from the first end 76 about 90 degrees to the first retaining arm end 120. When assembled, the first side retaining arm 92 of the first panel 84 is disposed in the first recess 70 of the first plate 38 and the first side retaining arm 92 of the second panel 86 is disposed in the first recess 70 of the second plate 40. The second side retaining arm 94 extends from the second end 78 and defines a curve 122 and a second retaining arm end 124. The curve 122 extends from the second end 78 about 90 degrees to the second retaining arm end 124. When assembled, the second side retaining arm 94 of the first panel 84 is disposed in the second recess 72 of the first plate 38 and the second side retaining arm 94 of the second panel 86 is disposed in the second recess 72 of the second plate 40.

While each of the first panel 84 and the second panel 86 has been illustrated as including a top retaining arm 90, a first side retaining arm 92, and a second side retaining arm 94, a panel of a contact member can include any suitable structure to accomplish attachment to a housing. For example, a panel of a contact member can include a top retaining arm, a first side retaining arm, and/or a second side retaining arm to accomplish attachment to a housing. While particular degrees of curvature have been described with respect to the curves 112, 118, 122 defined by the retaining arms 90, 92, 94, alternative embodiments can include a contact member that includes a retaining arm that defines a curve at any suitable degree of curvature such that attachment to a housing can be accomplished.

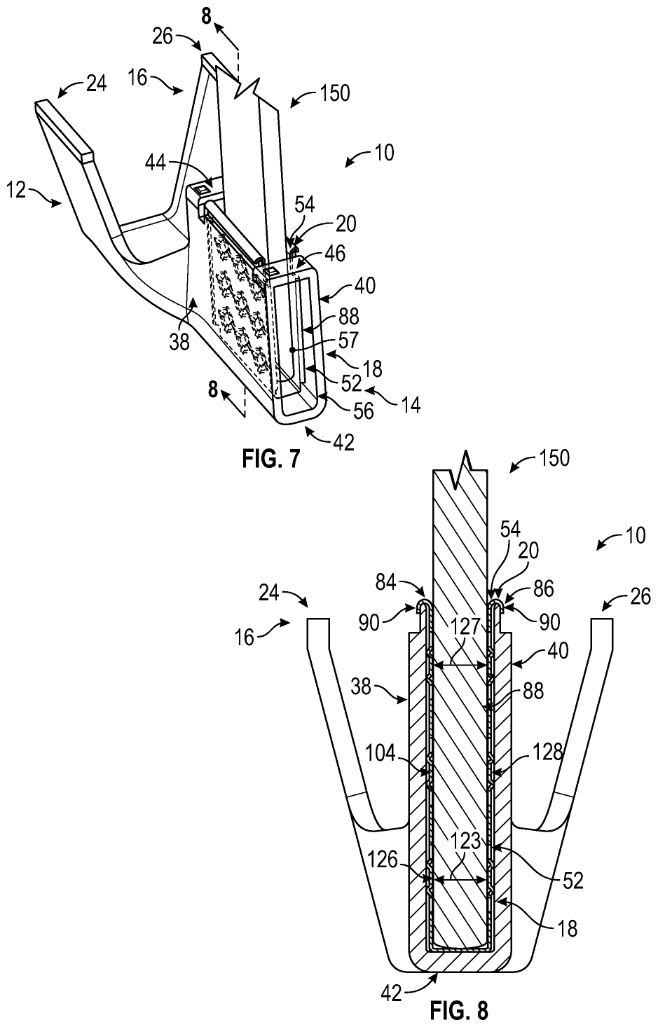

Each post of the plurality of posts 100 extends into the interspace 88 such that the contact point 104 is disposed within the interspace 88 and can contact an electrically conductive structure when the electrically conductive structure is positioned within the interspace 88. A first set of posts 126 of the plurality of posts 100 is disposed on the first panel 84 and a second set of posts 128 of the plurality of posts 100 is disposed on the second panel 86. Each post of the plurality of posts 100 is flexibly disposed on its respective panel 84, 86 such that each post of the plurality of posts 100 is moveable between a first position, as shown in FIGS. 1 through 6, in which it is free of contact with an electrically conductive structure disposed within the interspace 88, and a second position, as shown in FIGS. 7, 8, and 9, in which it contacts an electrically conductive structure disposed within the interspace 88. As shown in FIG. 6, in the first position, each contact point 104 of the first set of posts 126 is disposed a first distance 121 from the second panel 86 and each contact point 104 of the second set of posts 128 is disposed a first distance 125 from the first panel 84. As shown in FIG. 8, in the second position, each contact point 104 of the first set of posts 126 is disposed a second distance 123 from the second panel 86 that is greater than the first distance 121 and each contact point 104 of the second set of posts 128 is disposed a second distance 127 from the first panel 84 that is greater than the first distance 125. In addition, in the first position, as shown in FIG. 6, each post of the first set of posts 126 is disposed a distance 129 from a corresponding post of the second set of posts 128 that is less than the distance 39 between the first and second plates 38, 40.

While each of the first and second panels 84, 86 has been illustrated as including nine posts positioned at particular locations, a panel of a contact member can include any suitable number of posts positioned at any suitable location. Selection of a suitable number of posts to include on a panel and a suitable location to position a post on a panel can be based on various considerations, such as the desired current performance and/or retention force intended to be imparted on an electrically conductive structure positioned within an interspace defined by a contact member. Examples of orientations considered suitable to position a plurality of posts include such that the posts are positioned in rows with an equal number of posts in each row, the posts are positioned in rows with a varying number of posts in each row, the posts are positioned in an orientation that generally represents a geometric shape, such as a square, rectangle, circle, oval, diamond, the posts are positioned in an orientation that generally represents a symbol, such as an X, and any other orientation considered suitable for a particular embodiment.

Each slot of the plurality of slots 102 extends from the inner surface 96 to the outer surface 98, extends through a projection of the plurality of projections 108, and is disposed adjacent to, and extends radially outward from, the contact point 104. Each slot of the plurality of slots 102 provides flexibility to the post of the plurality of posts 100 of which it is a component such that the post can move between its first and second positions. In the illustrated embodiment, each slot of the plurality of slots 102 is elongated and, as shown in FIGS. 3A and 6, has a first end 130 disposed a first distance 131 from the contact point 104, and a second end 132 disposed a second distance 133 from the contact point 104 that is greater than the first distance 131.

While each slot of the plurality of slots has been illustrated as having a particular structural arrangement and as being positioned at a particular location relative to a contact point, a slot can have any suitable structural arrangement and be positioned at any suitable location on a panel to provide flexibility to a post. Examples of structural arrangements considered suitable for a slot included on a post include slots that are elongated, circular, square, rectangular, and any other shape considered suitable for a particular embodiment. Examples of locations considered suitable to position a slot relative to a contact point include locations in which a slot is disposed on a projection, locations in which a slot is disposed only on a projection of a post, locations in which a first portion of a slot is disposed on a planar surface of a panel (e.g., first panel 84, second panel 86) and a second portion of the slot is disposed on a post (e.g., a projection), and any other location considered suitable for a particular embodiment.

In the illustrated embodiment, the contact point 104 defines a curved surface 134 that extends into the interspace 88 and is centrally disposed between the plurality of slots 102 and within the recess 106. The contact point 104 contacts an electrically conductive structure when it is positioned within the interspace 88 providing an electrical connection between the contact member 20 and the electrically conductive structure. As an electrically conductive structure is advanced into the interspace 88 the electrically conductive structure moves the post of the plurality of posts 100 from the first position to the second position. As shown in FIG. 6, a first contact point 136 disposed on the first panel 84 is opposably positioned from a second contact point 138 disposed on the second panel 86 relative to the interspace 88. The first contact point 136 has a center 137 and the second contact point 138 has a center 139. In the illustrated embodiment, the center 137 of the first contact point 136 and the center 139 of the second contact point 138 are disposed on a hypothetical axis 141 that is disposed orthogonal to the inner surface 96 of the first panel 84. However, in alternative embodiments, a contact point disposed on a first panel can be positioned at any suitable location relative to a contact point on a second panel and relative to an inner surface of a panel or an interspace. For example, a first contact point disposed on a first panel can be offset relative to a second contact point disposed on a second panel such that a center of the first contact point and a center of the second contact point are disposed two different hypothetical axes that are disposed orthogonal to an inner surface of a first panel.

The recess 106 extends from the inner surface 96, away from the interspace 88, and toward the housing 18. The recess 106 is defined by a curved surface 140 through which a portion of each slot of the plurality of slots 102 extends. In the illustrated embodiment, the recess 106 completely surrounds the contact point 104. However, in alterative embodiments, a recess can at least partially surround a contact point and/or the entirety, or no portion, of a slot can extend through a curved surface that defines a recess. Depending on the thickness of the material forming a contact member, in some embodiments a recess can be omitted from a post.

The projection 108 extends from the outer surface 98, away from the interspace 88, and toward the housing 18. The projection 108 defines a curved surface 142. In the embodiment illustrated, the projection 108 completely surrounds the contact point recess 110. However, in alterative embodiments, a projection can partially surround a contact point recess and/or be omitted from a post depending on the thickness of the material forming a contact member. The projection 108 contacts with the housing 18 when the contact member 20 is disposed within the hollow socket 52 to provide an electrical connect between the contact member 20 and the housing 18.

In the illustrated embodiment, the contact point recess 110 extends from the projection 108 and away from the housing 18 and is defined by a curved surface 144. In the illustrated embodiment, the contact point recess 110 is centrally located within the projection 108. However, in alterative embodiments, a contact point recess can be disposed at any suitable location relative to a projection or can be omitted from a contact member.

While the contact member 20 has been illustrated as having a particular structural arrangement, a contact member can have any suitable structural arrangement and be formed of any suitable material. Selection of a suitable structural arrangement for a contact member can be based on various considerations, including the intended use of the electrical terminal of which the contact member is a component. For example, while the contact member has been illustrated as including first and second panels, alternative embodiments can utilize any suitable number of panels to accomplish an electrical connection between the electrical terminal and an electrically conductive structure. Examples of materials considered suitable to form a contact member include electrically conductive materials.

To assemble the electrical terminal 10, the bottom 82 of the contact member 20 is positioned adjacent to the first opening 54 of the housing 18. Subsequently, an axial force is applied on the contact member 20 directed toward the housing 18 until the bottom 82 of the contact member 20 advances into the hollow socket 52 of the housing 18. The axial force is continued until the first side retaining arm 92 of the first panel 84 is disposed in the first recess 70 of the first plate 38, the second side retaining arm 94 of the first panel 84 is disposed in the second recess 72 of the first plate 38, the first side retaining arm 92 of the second panel 86 is disposed in the first recess 70 of the second plate 40, and the second side retaining arm 94 of the second panel 86 is disposed in the second recess 72 of the second plate 40. In addition, the axial force is continued until the projection 68 defined by the first plate 28 is disposed within the recess 116 defined by the top retaining arm 90 of the first panel 84 and the projection 68 defined by the second plate 40 is disposed within the recess 116 defined by the top retaining arm 90 of the second panel 84.

The electrical terminal 10 can be used in combination with an electrically conductive structure in multiple ways and the way in which the electrical terminal 10 is used depends on the position of the electrical terminal 10 relative to other components in the system and/or the position of the electrically conductive structure relative to the electrical terminal 10. For example, as shown in FIG. 1, an electrically conductive structure 150, 152 can be inserted into the interspace 88 and between the first and second panels 84, 86 at either a 90 degree or 180 degree orientation relative to the lengthwise axis 11 of the electrical terminal 10. When the electrically conductive structure 150, 152 is positioned within the interspace 88, the plurality of posts 100 resiliently engage the electrically conductive structure 150, 152 to maintain its position within the interspace 88.

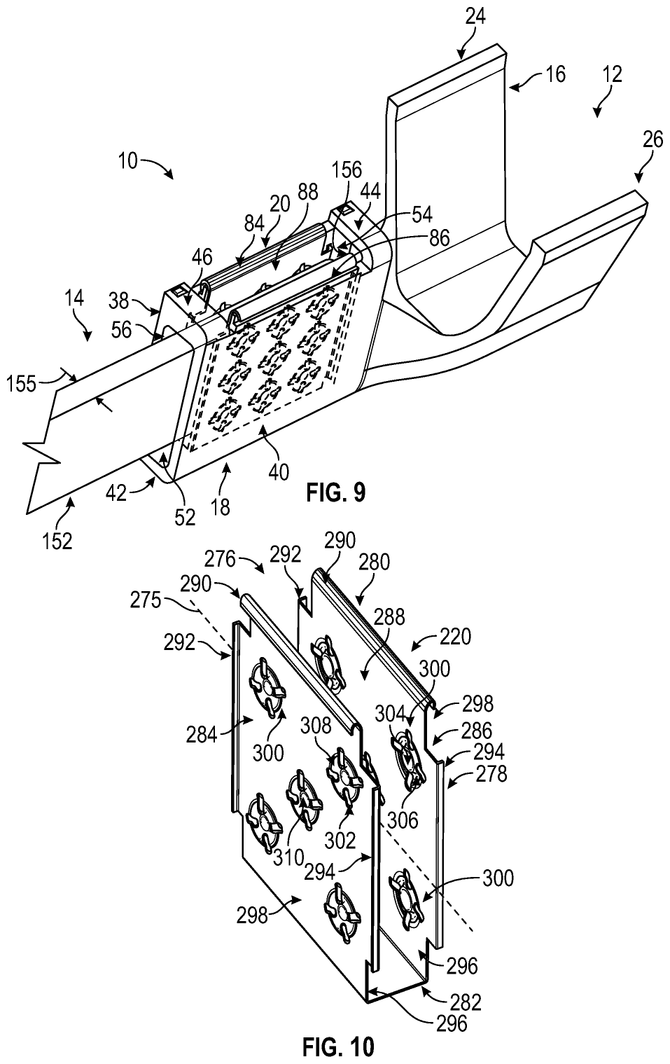

FIGS. 5 through 8 illustrate a second electrically conductive structure 150 that has a thickness 151 and an end 152. The second electrically conductive structure 150 is positioned through the first opening 54 of the housing 18 and within the interspace 88 defined by the contact member 20 such that the end 152 of the second electrically conductive structure 150 is disposed within the interspace 88. Alternatively, FIG. 9 illustrates a third electrically conductive structure 154 that has a thickness 155 and an end 156. The third electrically conductive structure 154 is positioned through the second opening 56 of the housing 18 and within the interspace 88 defined by the contact member 20 such that the end 156 of the third electrically conductive structure 154 is disposed within the interspace 88. Thus, an electrically conductive structure can be positioned within either the first opening 54 or the second opening 56 defined by the housing 18.

To accomplish positioning the second electrically conductive structure 150 within the interspace 88 of the contact member 20, as shown in FIGS. 5 through 8, the second electrically conductive structure 150 is positioned adjacent to the first opening 54 of the housing 18. Subsequently, an axial force is applied on the second electrically conductive structure 150 directed toward the housing 18 until the end 152 of the second electrically conductive structure 150 advances into the hollow socket 52 of the housing 18. The axial force is continued until the end 152 of the second electrically conductive structure 150 contacts, or is disposed adjacent to, the bottom 82 of the contact member 20. The positioning of each post of the plurality of posts 100 within the interspace 88 provides a mechanism for maintaining the position of the second electrically conductive structure 150 within the interspace 88. The distance 129 between each post of the first set of posts 126 from a corresponding post of the second set of posts 128 is less than the thickness 151 of the second electrically conductive structure 150. As a result, a retention force is created on the second electrically conductive structure 150 when it is disposed within the interspace 88.

To accomplish positioning the third electrically conductive structure 154 within the interspace 88 of the contact member 20, as shown in FIG. 9, the third electrically conductive structure 154 is positioned adjacent to the second opening 56 of the housing 18. Subsequently, an axial force is applied on the third electrically conductive structure 154 directed toward the housing 18 until the end 156 of the third electrically conductive structure 154 advances into the hollow socket 52 of the housing 18. The axial force is continued until the end 156 of the third electrically conductive structure 154 is disposed adjacent to the terminal body portion 16. In embodiments in which a first electrically conductive structure 28 is positioned within the terminal body portion 16, the axial force can be continued until the end 156 of the third electrically conductive structure 154 contacts, or is disposed adjacent to, the first electrically conductive structure 28. The positioning of each post of the plurality of posts 100 within the interspace 88 provides a mechanism for maintaining the position of the third electrically conductive structure 154 within the interspace 88. The distance 129 between each post of the first set of posts 126 from a corresponding post of the second set of posts 128 is less than the thickness 155 of the third electrically conductive structure 154. As a result, a retention force is created on the third electrically conductive structure 154 when it is disposed within the interspace 88.

Any suitable electrically conductive structure, having any suitable structural arrangement, and formed of any suitable material, can be used with in an electrical terminal. Selection of a suitable structural arrangement and material to form an electrically conductive structure can be based on various considerations, including the intended use of the electrical terminal. In the illustrated embodiment, the first electrically conductive structure 28 is a wire member 30 that includes an electrically conductive material 32 surrounded by an outer electrically non-conductive insulator 34 and each of the second and third electrically conductive structures 150, 154 is a flat male electrical blade formed of an electrically conductive material. As discussed above, electrical terminals are generally provided on a terminal end of an electrical conductor in an electrical system to complete a connection between one or more electrically operated devices and a source of electrical energy and/or other components of the electrical system. The electrically conductive structures 28, 150, 154 can be used for this purpose.

FIG. 10 illustrates an alternative contact member 220 for use with an electrical terminal. The contact member 220 has a lengthwise axis 275, a first end 276, a second end 278, a top 280, a bottom 282, a first panel 284, a second panel 286, and defines an interspace 288 between the first and second panels 284, 286. Each of the first and second panels 284, 286 has a top retaining arm 290, a first side retaining arm 292, a second side retaining arm 294, an inner surface 296, and outer surface 298, and a plurality of posts 300. Each post of the plurality of posts 300 has a plurality of slots 302, a contact point 304, a recess 306, a projection 308, and a contact point recess 310. In the illustrated embodiment, the contact member 220 is generally U-shaped. In the illustrated embodiment, the posts of the plurality of posts 300 are positioned in an orientation that generally represents an X.

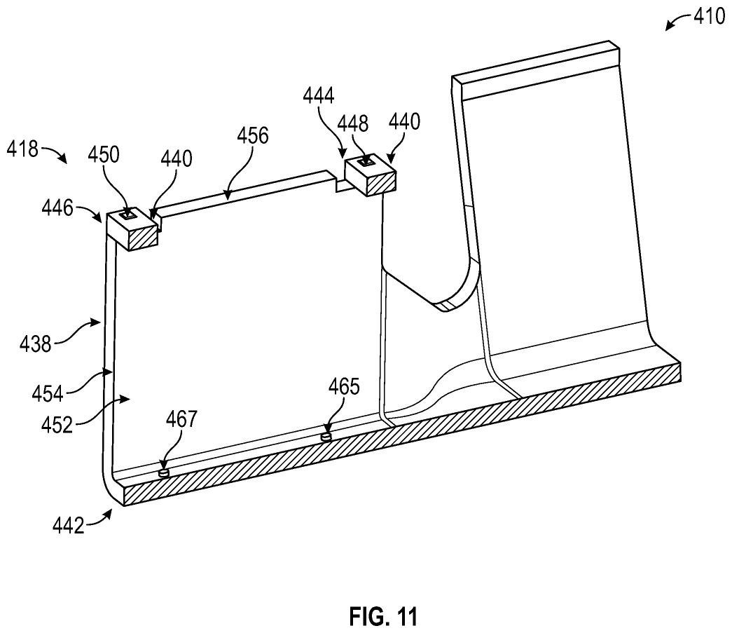

FIG. 11 illustrates an alternative terminal body portion 416 and housing 418 for use with an electrical terminal. In the illustrated embodiment, the housing 418 includes a first plate 438, a second plate 440, a base plate 442, a first connecting arm 444, a second connecting arm 446, a first projection 448, a second projection 450, and defines a hollow socket 452, a first opening 454, a second opening 456, a third projection 465, and a fourth projection 467. In the embodiment shown, each of the first and second plates 438, 440 omits the inclusion of a first and second recesses. Each of the third and fourth projections 465, 467 extends from the base plate 442 into the hollow socket 452 and is sized to be received by a passageway defined by a contact member to retain the contact member relative to the housing 418. Each of the third and fourth projections 465, 467 can be used to attach (e.g., via a rivet) a contact member to the housing 418.

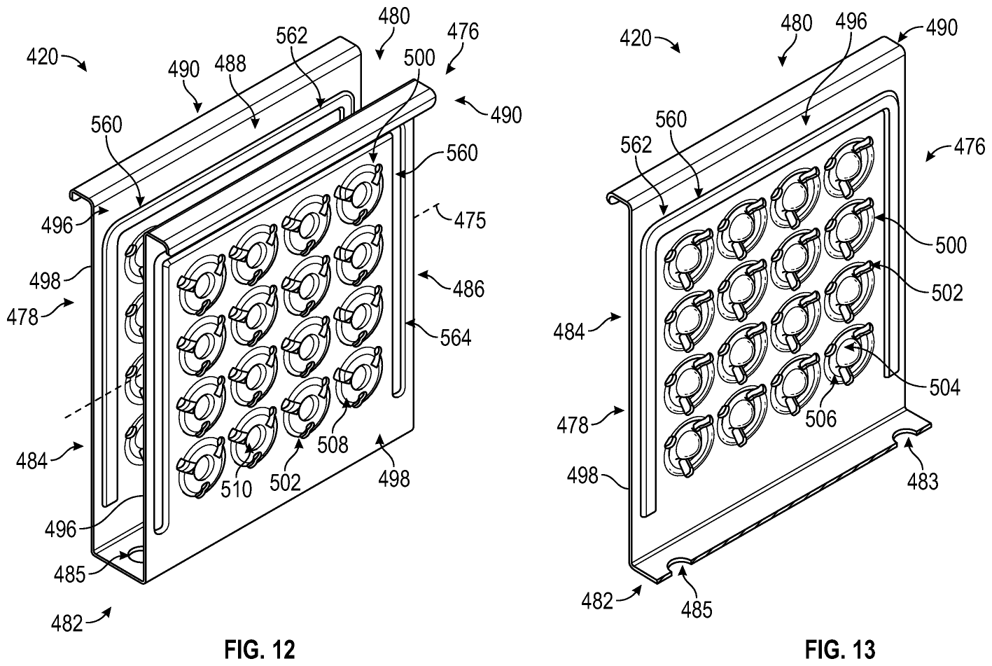

FIGS. 12 and 13 illustrate a contact member 420 for use with the terminal body portion 416 and housing 418 illustrated in FIG. 11. The contact member 420 has a lengthwise axis 475, a first end 476, a second end 478, a top 480, a bottom 482, a first panel 484, a second panel 486, and defines an interspace 488 between the first and second panels 484, 486. Each of the first and second panels 484, 486 has a top retaining arm 490, an inner surface 496, and outer surface 498, and a plurality of posts 500. Each post of the plurality of posts 500 has a plurality of slots 502, a contact point 504, a recess 506, a projection 508, and a contact point recess 510. In the illustrated embodiment, the contact member 420 is generally U-shaped and the contact member 420 omits the inclusion of a first side retaining arm and a second side retaining arm.

In the embodiment shown, the bottom 482 defines first and second passageways 483, 485, each of the first and second panels 484, 486 has a track 560 that partially extends around the plurality of posts 500, the plurality of posts 500 includes sixteen posts on each of the first and second panels 484, 486, and the plurality of slots 502 includes three slots on each post of the plurality of posts 500.

Each of the first and second passageways 483, 485 extends through the bottom 482 of the contact member 420. The first passageway 483 is sized to receive the third projection 465 of the housing 418, as shown in FIG. 11, and the second projection 485 is sized to receive the fourth projection 467 of the housing 418, as shown in FIG. 11. Each of the first and second passageways 483, 485 can be used to attach (e.g., via rivet) the contact member 420 to the housing 418.

The track 560 is defined by a projection 562 that extends from the inner surface 496 into the interspace 488 and a recess 564 that extends from the outer surface 498 toward the interspace 488. The track 560 provides an additional contact surface between the contact member 420 and an electrically conductive structure when the electrically conductive structure is disposed within the interspace 488. While the track 560 has been illustrated as partially surrounding the plurality of slots 500 and as having a particular structural arrangement, a track can be positioned at any suitable location on a contact member and have any suitable structural arrangement. For example, a track can entirely surround a plurality of posts and/or omit the inclusion of a recess.

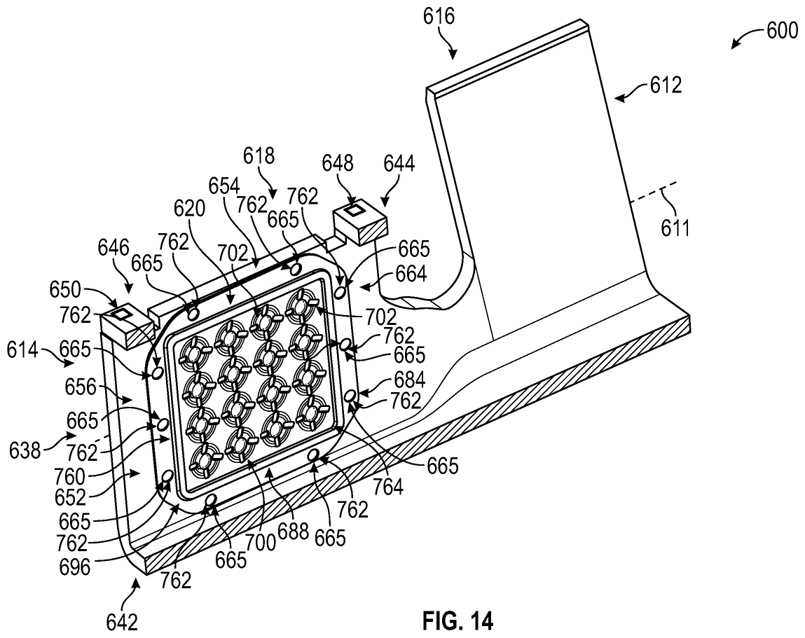

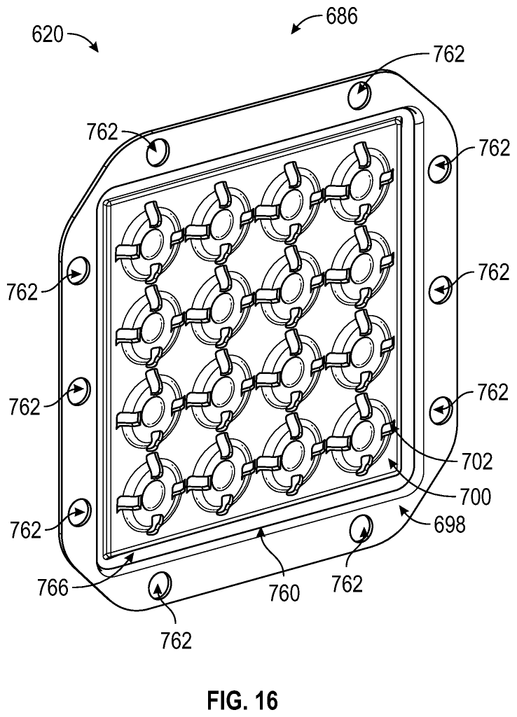

FIGS. 14 through 16 illustrate an alternative electrical terminal 600 that has a lengthwise axis 611, a first end 612, a second end 614, a terminal body portion 616, a housing 618, and a contact member 620.

In the illustrated embodiment, the housing 618 includes a first plate 638, a second plate 640, a base plate 642, a first connecting arm 644, a second connecting arm 646, a first projection 648, a second projection 650, and defines a hollow socket 652, a first opening 654, a second opening 656, a first plurality of projections 665 on the first plate 638, and a second plurality of projections 667 on the second plate 640. In the embodiment shown, each of the first and second plates 638, 640 omits the inclusion of a first and second recesses. Each projection of the first plurality of projections 665 extends from the inner surface 664 of the first plate 638 into the hollow socket 652 and each projection of the second plurality of projections 667 extends from the inner surface 664 of the second plate 640 into the hollow socket 652. Each projection of the first plurality of projections 665 is sized to be received by a passageway of the plurality of passageways 762 defined by the first panel 684 to retain the first panel 684 relative to the housing 618 (e.g., using a rivet). Each projection of the second plurality of projections 667 is sized to be received by a passageway of the plurality of passageways 762 defined by the second panel 686 to retain the second panel 686 relative to the housing 618 (e.g., using a rivet).

In the illustrated embodiment, the contact member 620 comprises a first panel 684 and a second panel 686. The first panel 684 is separate from, and free of, the second panel 686. The first and second panels 684, 686 cooperatively define an interspace 688 between the first and second panels 684, 686. In the embodiment illustrated, each of the first and second panels 684, 686 omits the inclusion of a top retaining arm, a first side retaining arm, and a second side retaining arm. Each of the first and second panels 684, 686 has a track 760 that extends entirely around the plurality of posts 700, a plurality of passageways 762, the plurality of posts 700 includes sixteen posts on each of the first and second panels 684, 686, and the plurality of slots 702 includes four slots on each post of the plurality of posts 700. The track 760 is defined by a projection 764 that extends from the inner surface 696 into the interspace 688 and a recess 766 that extends from the outer surface 698 toward the interspace 688. The track 760 provides an additional contact surface between the first and second panels 684, 686 and an electrically conductive structure when the electrically conductive structure is disposed within the interspace 688. Each passageway of the plurality of passageways 762 extends from the inner surface 696 to the outer surface 698.

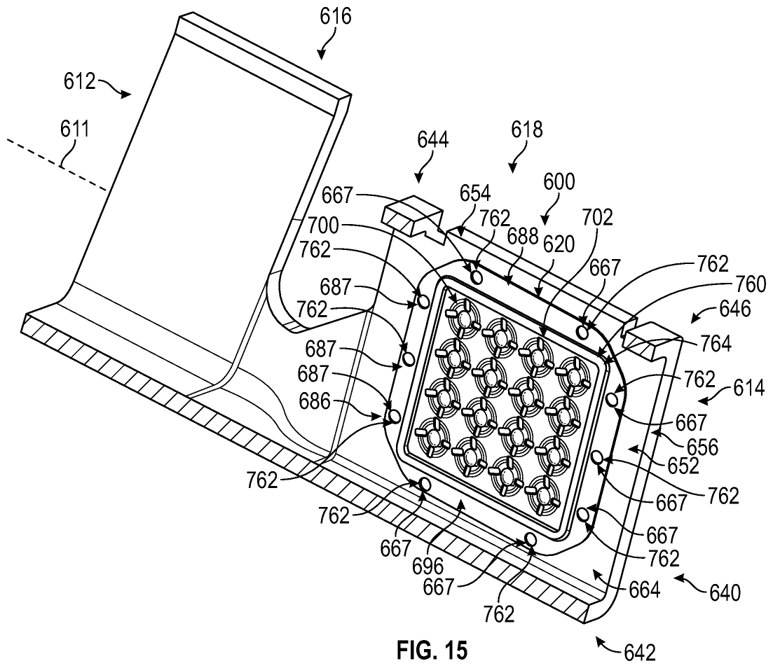

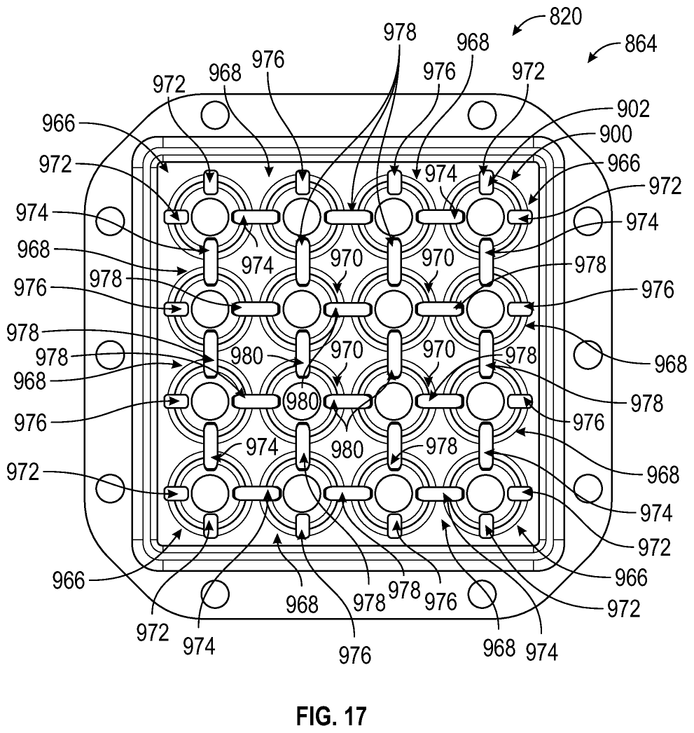

FIG. 17 illustrates a panel 864 of an alternative contact member 820 for use with the terminal body portion 616 and housing 618 illustrated in FIGS. 14 and 15. The panel 864 is similar to the first and second panels 684, 686 described in FIGS. 14 through 16 and described above, except as detailed below. In the illustrated embodiment, the plurality of posts 900 includes sixteen posts and the plurality of slots 902 includes four slots on each post of the plurality of posts 900.

A corner post 966 is disposed at each corner of the plurality of posts 900, two side posts 968 are disposed along each side of the plurality of posts 900 and between two corner posts 966, and four inside posts 970 are disposed between the corner posts 966 and the side posts 968. Each corner post 966 has two independent slots 972 and two shared slots 974. Each shared slot 974 is shared with a side post 968. Each side post 968 has one independent slot 976, one shared slot 974 shared with a corner post 966, and two shared slots 978. A first shared slot of the shared slots 978 is shared with a side post 968 and a second shared slot of the shared slots 978 is shared with an inside post 970. Each inside post 970 has two shared slots 978 shared with a side post 968 and two shared slots 980 shared with another inside post 970.

While the contact members 20, 220 described herein have been illustrated as being a component of an electrical terminal (e.g., electrical terminal 10), a contact member can optionally be provided independent of an electrical terminal such that it can be utilized in other components of an electrical system. Use of the electrical terminals described herein provide a mechanism for attaching an electrically conductive structure to an electrical terminal in multiple orientations relative to a housing of the electrical terminal, which reduces the complexity and time required to make an electrical connection between an electrical terminal and an electrically conductive structure.

The illustration of any component, element, or feature as being disposed above, below, left of, or right of another component, element, or feature is only with reference to the relative location of the components, elements, and features as shown in the figures in order to aid in describing the electrical terminals and contact members. Accordingly, the components, elements, or features illustrated and described herein can be oriented in any manner desired without departing from the spirit or scope of the invention.

Those with ordinary skill in the art will appreciate that various modifications and alternatives for the described and illustrated embodiments can be developed in light of the overall teachings of the disclosure, and that the various elements and features of one example described and illustrated herein can be combined with various elements and features of another example without departing from the scope of the invention. Accordingly, the particular examples disclosed herein have been selected by the inventor(s) simply to describe and illustrate examples of the invention and are not intended to limit the scope of the invention or its protection, which is to be given the full breadth of the appended claims and any and all equivalents thereof.

What is claimed is:

1. A contact member for an electrical terminal comprising:
a first panel, a second panel, and an interspace defined between the first panel and the second panel;
each of the first and second panels having a plurality of posts, each post of the plurality of posts having a plurality of slots and a contact point, each slot of the plurality of slots disposed adjacent to the contact point, each post of the plurality of posts extending into the interspace such that the contact point is disposed within the interspace; and
each post of the plurality of posts moveable between a first position and a second position, in the first position the contact point of each post of the plurality of posts of the first panel is disposed a first distance from the second panel, in the second position the contact point of each post of the plurality of posts of the first panel is disposed a second distance from the second panel that is greater than the first distance.

2. The contact member of claim 1, wherein each slot of the plurality of slots extends radially outward from the contact point.

3. The contact member of claim 1, wherein each slot of the plurality of slots has a first end disposed a first distance from the contact point and a second end disposed a second distance from the contact point that is greater than the first distance.

4. The contact member of claim 1, wherein the first panel has an inner surface and an outer surface; and
wherein each slot of the plurality of slots of the first panel extends from the inner surface to the outer surface.

5. The contact member of claim 1, wherein the first panel has an inner surface and an outer surface; and
wherein each post of the plurality of posts of the first panel has a recess extending from the inner surface and away from the interspace, the recess at least partially surrounding the contact point.

6. The contact member of claim 5, wherein the recess entirely surrounds the contact point.

7. The contact member of claim 1, wherein the first panel has an inner surface and an outer surface; and
wherein each post of the plurality of posts of the first panel has a projection extending from the outer surface and away from the interspace.

8. The contact member of claim 7, wherein each post of the plurality of posts of the first panel has a contact point recess; and
wherein the projection at least partially surrounds the contact point recess.

9. The contact member of claim 8, wherein the contact point recess is centrally located within the projection.

10. The contact member of claim 1, wherein said contact member is generally U-shaped.

11. The contact member of claim 1, wherein a first contact point disposed on the first panel is opposably positioned from a second contact point disposed on the second panel relative to the interspace.

12. An electrical terminal comprising:
a terminal body portion and a housing extending from the terminal body portion, the housing defining a hollow socket; and
a contact member retained within the hollow socket, the contact member including a first panel, a second panel, and defining an interspace between the first panel and the second panel, each of the first and second panels having a plurality of posts, each post of the plurality of posts having a plurality of slots and a contact point, each slot of the plurality of slots disposed adjacent to the contact point, each post of the plurality of posts extending into the interspace such that the contact point is disposed within the interspace, each post of the plurality of posts moveable between a first position and a second position, in the first position the contact point of each post of the plurality of posts of the first panel is disposed a first distance from the second panel, in the second position the contact point of each post of the plurality of posts of the first panel is disposed a second distance from the second panel that is greater than the first distance.

13. The electrical terminal of claim 12, wherein each slot of the plurality of slots extends radially outward from the contact point.

14. The electrical terminal of claim 12, wherein each slot of the plurality of slots has a first end disposed a first distance from the contact point and a second end disposed a second distance from the contact point that is greater than the first distance.

15. The electrical terminal of claim 12, wherein the first panel has an inner surface and an outer surface; and
wherein each post of the plurality of posts of the first panel has a recess extending from the inner surface and away from the interspace, the recess entirely surrounding the contact point.

16. The electrical terminal of claim 12, wherein the first panel has an inner surface and an outer surface; and
wherein each post of the plurality of posts of the first panel has a projection and a contact point recess, the projection extending from the outer surface and away from the interspace, the projection at entirely surrounding the contact point recess.

17. The electrical terminal of claim 12, wherein a first contact point disposed on the first panel is opposably positioned from a second contact point disposed on the second panel relative to the interspace.

18. The electrical terminal of claim 12, wherein the housing defines a first opening and a second opening, each of the first and second openings providing access to the hollow socket.

19. The electrical terminal of claim 18, wherein the hollow socket has a hollow socket center;
wherein the first opening has a first opening center;
wherein the second opening has a second opening center; and
wherein the first opening center and the second opening center are offset by about 90 degrees relative to the hollow socket center.

20. An electrical terminal comprising:
a terminal body portion and a housing extending from the terminal body portion, the housing defining a first opening, a second opening, and a hollow socket, each of the first and second openings providing access to the hollow socket; and
a contact member retained within the hollow socket, the contact member including a first panel, a second panel, and defining an interspace between the first panel and the second panel, each of the first and second panels having a plurality of posts, each post of the plurality of posts having a plurality of slots, a contact point, a recess entirely surrounding the contact point, a projection, and a contact point recess, each slot of the plurality of slots disposed adjacent to the contact point and extending radially outward from the contact point, each post of the plurality of posts extending into the interspace such that the contact point is disposed within the interspace, the projection entirely surrounding the contact point recess, each post of the plurality of posts moveable between a first position and a second position, in the first position the contact point of each post of the plurality of posts of the first panel is disposed a first distance from the second panel, in the second position the contact point of each post of the plurality of posts of the first panel is disposed a second distance from the second panel that is greater than the first distance.
